(19) United States
(12) Patent Application Publication
(10) Pub. No.: US 2006/0040243 A1
(43) Pub. Date: Feb. 23, 2006

(54) Seriously funny (SF)

(76) Inventor: Roc Elie Celiant, Yonkers, NY (US)

Correspondence Address: Roc Elie Celiant, 6 Thurman St., Yonkers, NY, 10701, US

(21) Appl. No.: 10/683,983

(22) Filed: Aug. 23, 2004

(51) Int. Cl. G09B 19/00

(52) U.S. Cl. 434/245

(57) ABSTRACT

Most everybody uses deck of cards and plays “cards”. Using the “card playing know-how” of the believers, this game offers the opportunity to play cards to have fun but while doing so, people will effordlessly learn and memorize Bible's passages, stories and ethics. The relaxation of a game setting replaces the transcendental stressful environment of either a Sunday school or a Bible study. People will be snacking, jocking, standing, sitting, laughting etc. They will not be studying the Bible, but playing, and yet, unconsciously embedding the Bible in their brain. Because they will not be trying to learn anything. But everything they will be interacting with will sink in their memory. Almost like the same principle that television uses to push commercials into people's brain. By having fun interacting with the cards, their messages will find their way in the brain of the players.

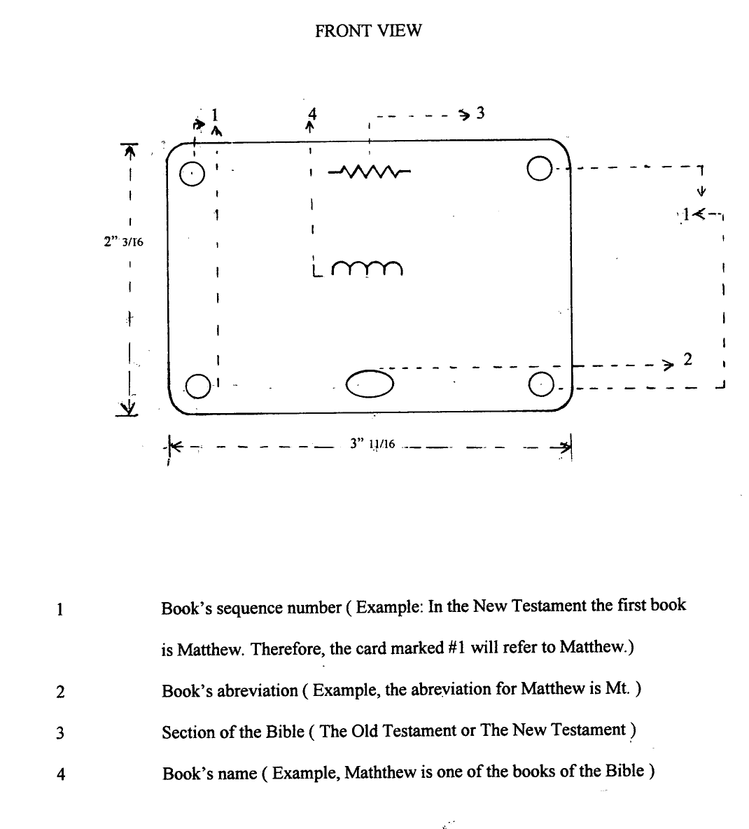

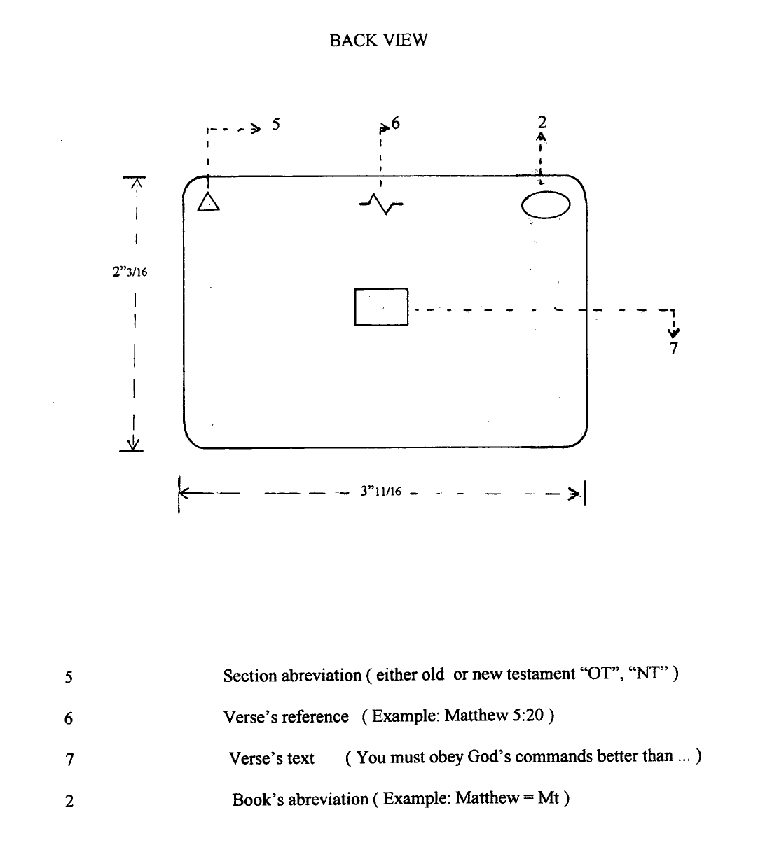

### FIELD OF INVENTION

Formation and education of bielivers of all ages to stimulate their growth and straintenth their faith.

I have witnessed trimendous progress in past baptismal class where when the believers get fun doing something, they remember most the details about it. This fact inspire me to invent these cards to stimulate their interest in reading the Bible and their ability to memorise, quote, and apply Bible verses.

### DESCRIPTION OF THE RELATED ART

The invention so named “Seriously Funny” uses the concept of card playing to provide to christian leaders a sure tool to help the believers learn and painlessly memorize Bible verses and the Christian ethics. No special material is needed, just one or more decks of cards and people willing to have fun. The cards come with a set of smaller size cards one for each book with the name of the corrresponding book on one side and the corresponding sequencial number on the book other side, which will be used to start the game in levels 2 to 4. All under an heavy lamination for longer life span and easier cleaning when needed. It is a fact that human brain is more receptive when stress of any kind is not involved. And this game does just that, while exposing the players to the word of the Bible that church leaders have so much troubles to anchor in their members' mind. The christian believers are called to be “the salt of the world”, which they cannot be if they do not live by the teachings of the Bible. But the fact is that they cannot live by the teachings of the Bible if they do not memorize them. Psalm 119:11 puts it this way: “I have hidden your word in my heart that I might not sin against you . . . ” This game will do just that better than any former method or material available.

### BRIEF SUMMARY OF THE INVENTION

Bible verse learning cessions are usually identical to school. Though they are generally held mostly on Sunday, and in church setting, they usually stress the persons concerned as though they were an extention of regular school causing Bible verses learnig and christian ethics harder to be assimilated. With this cards, the whole matter of teaching, learning, memorizing is simplified, captivating and stress-free to all, because they are only playing. And the different levels of the game makes it profitable for the little ones, the grown-ups and adults alike at their respective level.

When we remember that game in general always aim at a certain age group, and that the growth of all believer dependson the Bible, “Seriously Funnny” is a one of a kind. The same and only one material offers to all the different age groups the exceptional opportunity to master the Bible and make the christian ethics practice a second nature.

### DETAILED DESCRIPTION OF THE INVENTION

Levels

1:

Each player calls each card while rearanging the deck. “Skiping, or failling to call a card ?—must learn that verse.” The shortest time wins.
   2:
Each player picks a card. Their difference (smaller, bigger or equal to the smaller) is the number of books to name. Miss a book? Learn the verse.
Difference:
   Smaller; go backward
   Bigger; go forward
   Equal; all learn both verses.—Then restart
      3:
Choose one. For each mistake:
a) Learn that book's verse.
b) Tell a story from that book, pray, or sing.
c) Both “a, b”
d) Both say a verse from that book, or learn that card's verse.
   4
Start, 10 cards each._Cannot beat a card?
Search a card (from deck).
Or
Cry (drop any card, say or learn both verses). Winer picks two cards for oponent to learn.

1. Learning and memorizing Bible verses and the Christian ethics are so vital to the believer's maturity that a tool such as Seriously Funny (SF) is overdue. After years of deep thinking I come up with this game which will make believers of all age roar with laugher while playing with Bible verses which some will discover for the first time, others will review, but all will master painlessly and memorize simply by having fun playing with these cards. None other has ever come up with a so serious and yet so fun to use method. Therefore, I claim it as my invention, and I call it “Seriously Funny” (SF).
Because learning the Bible is the reason for the card, but even in doing so people will have so much fun. I am pleased to have made a tool such as “Seriously Funny” available to Believers of the Bible.
